(19) United States
(12) Patent Application Publication
(10) Pub. No.: US 2009/0218725 A1
(43) Pub. Date: Sep. 3, 2009

(54) INJECTION MOLDED PANELED MOBILE DEVICE ENCLOSURE

(75) Inventors: Carl Thelemann, East Islip, NY (US); Thomas Wulff, North Patchogue, NY (US); Carl DeGiovine, Shirley, NY (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 12/040,688

(22) Filed: Feb. 29, 2008

(51) Int. Cl. B28B 5/00

(52) U.S. Cl. 264/251

(57) ABSTRACT

Systems, devices and/or methods that facilitate thinner form factors and/or more robust mobile device enclosures by injection molding mobile device enclosures with panels are presented. These panels can include display panels, window panels and touch sensitive panels. Further, panels can be insert molded. Additionally, select panels can be contemporaneously molded by multi-shot injection molding at least a portion of the panel and a portion of the enclosure body. Multi-shot injection molding can include 2-shot injection molding, multi-shot injection molding, and co-injection injection molding. Injection molding a mobile device enclosure with a panel can provide improved form factor mobile device enclosures and/or provide a more robust mobile device enclosure than many traditional methods.

### TECHNICAL FIELD

The subject innovation relates generally to injection molded mobile device enclosures, systems, and/or methods and more particularly to injection molded mobile device enclosures, systems, and/or methods having window panels and/or touch sensitive panels therein to facilitate lower profile and more robust mobile device enclosures.

### BACKGROUND

Traditionally, mobile device enclosures are employed to enclose a computer or computer device generally to protect sensitive internal electronics. These mobile device enclosures traditionally have a window panel or interface panel attached to an enclosure body by mechanical fasteners, bezels, glues, or are mechanically bonded by techniques such as sonic welding or heat-stacking. These methods of attaching a panel (e.g., a window panel or interface panel) to the enclosure body can result in relatively thick mobile device enclosures. For example, where a touch sensitive panel is attached by a sonically welded bezel to an enclosure, the stacked structure of the enclosure the panel and the bezel can be thick in comparison to the thickness of the enclosed mobile device.

Further, these traditional mobile device enclosures can provide a limited level of ruggedness and protection from external environments. Where, for example, a window panel is attached to an enclosure body by a mechanical fastener (e.g., screw, rivet, . . . ) gaps can occur between the mechanically fastened portions. These gaps can allow contaminants (e.g., dust, dirt, moisture, . . . ) to enter into the mobile device enclosure. Similarly, for example, where a touch sensitive panel is attached by a sonically welded bezel to an enclosure, there can be voids between the bezel and the touch sensitive panel and/or the touch sensitive panel and the enclosure, which can provide a pathway for exposure of the enclosed mobile electronic device to external contaminants (e.g., dust, dirt, moisture, . . . ).

Additionally, the conventional methods of securing a panel to an enclosure body can result in areas of higher stress in the panel or the enclosure body that can result in failures in the bond or attachments between the panel and the enclosure body. For example, where a window panel is glued into an enclosure body, the glue can fail and result in a less protective and rugged enclosure. Similarly, by example, where a window panel is attached by mechanical fasteners, the fastening points can become weak and fail (e.g., tapped screw holes in the enclosure body can crack or strip-out, rivets can wear through thin window panels, . . . ). Where these methods of attachment fail, the electronic components can be exposed to damage or contamination.

Traditional paneled mobile device enclosures (e.g., mobile device enclosures with traditionally attached window panels, touch sensitive panels, . . . ) can provide limited protection, limited ruggedness, and non-optimal form factors. As a result of these deficiencies, end users can be exposed to premature mobile device failures, bulkier mobile devices, or can be forced to employ additional protections for mobile devices with more fragile traditional mobile device enclosures.

### SUMMARY

The following presents a simplified summary of the disclosed subject matter in order to provide a basic understanding of some aspects described herein. This summary is not an extensive overview of the disclosed subject matter. It is intended to neither identify key or critical elements of the disclosed subject matter nor delineate the scope of the subject innovation. Its sole purpose is to present some concepts of the disclosed subject matter in a simplified form as a prelude to the more detailed description that is presented later.

Injection molded mobile device enclosures, systems and/or methodologies for integrating a panel into the mobile device enclosure can result in a more rugged mobile device enclosure and/or a more optimal form factor profile for the mobile device enclosure. This in turn can prolong the life of mobile devices housed in the enclosures. In an aspect, an injection molded enclosure can be insert molded with a panel (e.g., window panel, display panel, touch sensitive panel, . . . ). In another aspect, an injection molded enclosure can be multi-shot injection molded with a panel (e.g., window panel, . . . ). Mobile device enclosures that are injection molded (e.g., insert molded, multi-shot injection molded, . . . ) with a panel can result in a more optimal profile for the join between portion of the panel and the body of the enclosure (e.g., thinner). Further, mobile device enclosures that are injection molded (e.g., insert molded, multi-shot injection molded, . . . ) with a panel can result in mechanical, chemical, adhesive, or weld-type interfaces between the panel and the enclosure body that can be more resistant to the intrusion of external elements into the mobile device enclosure. Moreover, mobile device enclosures that are injection molded (e.g., insert molded, multi-shot injection molded, . . . ) with a panel can result in improved mobile device enclosure ruggedness wherein the interface between the panel and the enclosure body can be more distributed and/or more rugged than conventional methods.

To the accomplishment of the foregoing and related ends, the disclosed subject matter, then, comprises the features hereinafter fully described and particularly pointed out in the claims. The following description and the annexed drawings set forth in detail certain illustrative embodiments of the disclosed subject matter. These embodiments can be indicative, however, of but a few of the various ways in which the principles of the disclosed subject matter can be employed. Other objects, advantages, and novel features of the disclosed subject matter will become apparent from the following detailed description of the disclosed subject matter when considered in conjunction with the drawings.

### BRIEF DESCRIPTION OF THE DRAWINGS

FIG. 1 is a diagram of a system that can facilitate an improved paneled mobile device enclosure in accordance with an aspect of the subject matter disclosed herein.

FIG. 2 is a diagram of a system that can facilitate an improved window paneled mobile device enclosure in accordance with an aspect of the subject matter disclosed herein.

FIG. 3 is a diagram of a system that can facilitate an improved window paneled mobile device enclosure in accordance with an aspect of the subject matter disclosed herein.

FIG. 4 is a diagram of a system that can facilitate an improved touch sensitive paneled mobile device enclosure in accordance with an aspect of the subject matter disclosed herein.

FIG. 5 is a schematic illustration of a system that can facilitate an improved paneled mobile device enclosure in accordance with an aspect of the subject matter disclosed herein.

FIG. 6 illustrates a methodology that can form an improved paneled mobile device enclosure in accordance with an aspect of the subject matter disclosed herein.

FIG. 7 illustrates a methodology that can form an improved windowed paneled mobile device enclosure by multi-shot injection molding in accordance with an aspect of the subject matter disclosed herein.

FIG. 8 illustrates a methodology that can facilitate an improved touch sensitive paneled mobile device enclosure in accordance with an aspect of the subject matter disclosed herein.

### DETAILED DESCRIPTION

The disclosed subject matter is described with reference to the drawings, wherein like reference numerals are used to refer to like elements throughout. In the following description, for purposes of explanation, numerous specific details are set forth in order to provide a thorough understanding of the disclosed subject matter. It is evident, however, that the disclosed subject matter can be practiced without these specific details. In other instances, well-known structures and devices are shown in block diagram form in order to facilitate describing the subject innovation.

Conventionally, mobile device enclosures can have window panels or interface panels attached by mechanical fasteners, sonic welding, heat-stacking, gluing, and the like. End users of modern mobile devices generally desire that the mobile device (e.g., a mobile device in a paneled enclosure) be as thin as possible and as rugged as possible. Conventional techniques for attaching a window panel, touch sensitive panel, or other panel, can result in mobile device enclosures that have non-optimal form factors and/or posses a limited level of ruggedness.

Conventional paneled mobile device enclosures can lack an optimal form factor because conventional methods of attaching a panel (e.g., window, touch sensitive panel, display panel, . . . ) to the enclosure can require additional space for mechanical fastening systems, additional space for layering of materials, additional space for applying tooling to attach the panel to the enclosure body, or combinations thereof, among other increased space factors. For example, where a window panel can be mechanically secured between an enclosure body and a bezel member, the stack of materials results in a less than optimal for form factor. Similarly, where a display panel, for example, is sonically welded to an enclosure body, the panel will typically be stacked on the body for welding resulting in a thick (e.g., non-optimal) form factor. Additionally, in the sonic welding example, tooling space to bring in the sonic welding anvil can be required, which can reduce the available area for the display or, conversely, require an increase in the enclosure body size for a given panel size. In yet another example, where a touch sensitive panel is attached with an adhesive, the panel can typically be stacked on the enclosure body with a layer of adhesive disposed therebetween, again resulting in a non-optimal form factor.

Further, conventional paneled mobile device enclosures can lack ruggedness. Where a panel is attached to an enclosure body, the method of attachment can fail. For example, adhesives can delaminate, screw holes can crack with aging causing a screw fastener to become loose, and the like. The stresses on the points of attachment in a conventional paneled enclosure can also increase with the proportion of the panel area to the enclosure. For example, in a personal digital assistant (PDA), where the display window panel is of a significant size compared to the face of the mobile device enclosure, stresses (e.g., torsional stresses, among many others) on the PDA at the point of attachment between the display window panel and the enclosure body can be significantly higher than, for example, in a desktop calculator where the display panel is of a less significant proportion of the face of the mobile device enclosure. Given the trend in modern mobile electronic devices to employ larger and larger panels (e.g., a modern cellular telephone can have a very large screen and very little “enclosure body” on the face of the cellular phone as compared to older cell phones, this same trend is clearly visible in other mobile electronic devices, such as, personal music devices, global positioning satellite (GPS) devices, personal voice recorders, . . . ), traditional methods of attaching a panel to a mobile device enclosure body can result in earlier and more frequent failures for lack of ruggedness.

In accordance with one aspect of the disclosed subject matter, a mobile device enclosure can be injection molded with a panel (e.g., window panel, touch sensitive panel, display panel, . . . ). This can result in an improved form factor and/or improved ruggedness. For example, a mobile device enclosure can be molded to a panel such that the panel and the proximal portion of the mobile device enclosure body are at least partially coplanar resulting in a very thin form factor as compared to conventional methods as herein discussed. Additionally, for example, coplanar injection molding can result in the “window opening” in the enclosure body being completely filled with the window panel itself (as compared to a conventional method of layering the window panel above or below an enclosure body layer having a “window opening” therein). By filling the “window opening” with the window, the resulting paneled mobile device enclosure can be more rigid than a conventional laminated enclosure. Further, the injection molding can be tailored to thermally weld the panel to the enclosure body to further improve ruggedness, or can be tailored to mechanically interconnect with the panel to allow for permanent or removable panels (e.g., allowing replacement of the panel at a future time). Further, chemical or adhesive connections can be formed in an injection molding process, as herein discussed. One of skill in the art will appreciate that numerous permutations of the particular conditions of the injection molding process to achieve specific design goals are possible and that all such permutations are considered within the scope of the disclosed subject matter.

Injection molding an enclosure body with a panel can include insert molding, two-shot molding, multi-shot molding, co-injection molding, or other process in which either the panel or the enclosure body is injection molded to cause merging of the materials (e.g., welding, fusing, . . . ) of the panel and enclosure body and/or a mechanical, chemical, or other interface, or combination thereof, relative to the panel and the enclosure body. For example, a preformed plastic window panel can be placed in an injection mold for a GPS case, whereby the GPS case can be injection molded to the inserted window panel (e.g., insert molding being a subclass of injection molding). The injection molding of the GPS enclosure body can cause the plastic of the edges of the window panel to partially or completely melt, comingle with the injected plastic forming the enclosure body, and reharden as the insert molded paneled GPS enclosure cools. The resulting paneled GPS enclosure is functionally a single part wherein the window panel is molecularly fused with the enclosure body. One of skill in the art will appreciate that insert molding (e.g., injection molding) can also be employed for non-fused or non-weld type interfaces (e.g., mechanical interfaces, adhesive interface, chemical bond interfaces, . . . ) and that all such interfaces are considered within the scope of the disclosed subject matter and are not limited by the given example immediately above.

As used in the art, the term insert molding (also called overmolding) (e.g., injection molding) is generally considered a type of injection molding and the terms can often be used interchangeably. Insert molding is generally a process by which an object, or insert, is placed into a mold between cycles and the material of the remainder of the object being formed is formed at least partially around the insert. By doing so, the object can become a part of the final molded product or a detail of the insert can be left on the formed part. The materials used as inserts can typically include a variety of metallic inserts, plastic inserts, glass inserts, cloth, retaining rings, or film, among a nearly limitless number of other types of application specific materials that can be inserted. For example, a metallic core can be inserted into the mold to become part of the molded part or to leave its profile in the molded part. These cores can be used to create threads in the molded part and an operator or automation fixture in the post-mold process can back them out. Metallic inserts can also be used to increase the strength of the molded part or to create a metallic threaded-hole or through-hole. As a second example, a plastic window panel can be inserted into the mold to become part of the resulting molded assembly.

Typically, insert molding (e.g., injection molding) includes a custom-built mold that can be loaded with inserts. Inserts can be loaded robotically or manually. The mold can then have molten material injected into the mold where, upon cooling, the mold can be opened and the components removed. Components are then separated from the sprues and inspected. Further, post-molding assembly can include a variety of secondary operations, such as die cutting, bonding, microsoldering, or circuit testing, among a nearly limitless number of other post, molding process appropriate to the specific item being formed.

Typical inset molding (e.g., injection molding) has advantages including possible reduced assembly and labor costs (e.g., where insert molding can join numerous components with thermoplastic in a single step, labor costs can be reduced), reduced size and weight (e.g., by eliminating fasteners and connectors, and by combining the physical strength of the injected material with the inserts, insert molding can yield smaller, lighter, and/or thinner components), increased reliability (e.g., with every part tightly secured in the injected material, an insert molded component can prevent part loosening, misalignment, improper terminations, and other problems), improved resistance to shock and/or vibration (e.g., the injected material can act as a shock absorber or damper), increased design flexibility, (e.g., when overmolding circuitry, the components can be placed throughout the part (from inside to outside, up walls, down in holes, . . . ), and the injected material ties it all together).

Similarly, the broader class of injection molding can include multi-shot injection molding (MIM). Typically, MIM uses a custom mold into which a first material is molded and then a second material is molded. In co-injection molding (a type of MIM) both materials can be contemporaneously injected into a custom mold to form an assembly. These injection molding processes and the related sub-classes of injection molding (e.g., insert molding, MIM, co-injection molding, . . . ) can be employed in forming paneled mobile device enclosures in accordance with the disclosed subject matter.

The subject innovation is hereinafter illustrated with respect to one or more arbitrary systems for performing the disclosed subject matter. However, it will be appreciated by one of skill in the art that one or more aspects of the subject innovation can be employed in other injection molded mobile device enclosure systems and is not limited to the examples herein presented.

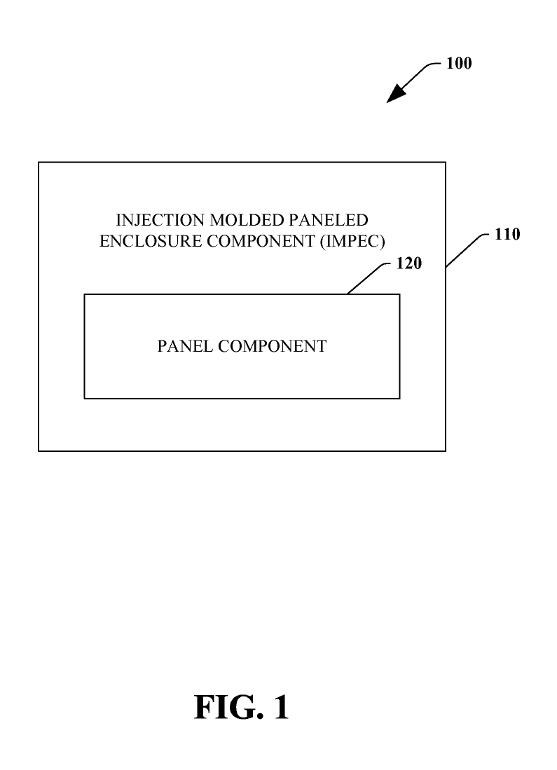

Turning to FIG. 1, illustrated is a system 100 that can facilitate an improved paneled mobile device enclosures in accordance with an aspect of the subject matter disclosed herein. System 100 can include an injection molded paneled enclosure component (IMPEC) 110 that can include one or more panel components 120. The IMPEC 110 can be an injection molded mobile device enclosure formed of a plastic or rubber material, among other materials. Further, the IMPEC 110 can be injection molded (e.g., insert molded, two-shot injection molded, multi-shot injection molded, co-injection molded, . . . ) with panel component 120.

The injection molding of IMPEC 120 with panel component 120 can form a connection between potions of the panel component 120 and the IMPEC 110. Further, the panel component 120 can be injection molded with the IMPEC 110 (e.g., in one embodiment the panel component 120 is insert molded into the IMPEC 110, in another embodiment the IMPEC 110 is insert molded into the panel component 120). These connections can be “weld-type” connections (e.g., thermal bonding or thermal filler bonding connections), mechanical connections, chemical connections, adhesive connections (e.g., a layer of adhesive is disposed between at least a portion of the IMPEC 110 and the panel component 120), or combinations thereof.

A “weld-type” connection can cause portions of the material of the panel component 120 to partially or completely melt and comingle with portions of the IMPEC 110. Additionally, where thermal filler bond connections are to be formed, a thermal filler material can partially or completely melt and comingle with the materials of the panel component 120, the IMPEC 110, or combinations thereof. The weld-type connection implies that the separate materials of the IMPEC 110 and panel component 120 are fused together either with or without one or more filler materials.

Mechanical connections can cause portions of panel component 120 to be mechanically interconnected (either permanently or removably) with portions of the IMPEC 110. One example of a mechanical connection can be the IMPEC 110 being injection molded so as to fill a perimeter groove of the panel component 120 such that the panel component 120 is retained in the IMPEC 110. One of skill in the art will appreciate that a nearly limitless number of mechanical connection permutations exist, which are far too numerous to enumerate here, and that all such connections, coplanar and/or non-coplanar are to be considered within the scope of the disclosed subject matter.

An adhesive connection can be formed between the panel component 120 and the IMPEC 110. The adhesive connection can include one or more adhesive layers disposed between at least a portion of the panel component 120 and at least a portion of the IMPEC 110. Further, the adhesive connection can include portions of either the panel component 120 or the IMPEC 110 being adhesive in and of itself so as to adhere to the other component. In one embodiment in accordance with the disclosed subject matter, a layer of adhesive can be applied to the perimeter of a panel component 120 that is then insert molded into an IMPEC 110, wherein the adhesive layer adheres the panel component 120 to the IMPEC 110 where it is formed in abutment to the panel component 120.

A chemical connection can be formed between the panel component 120 and the IMPEC 110. The chemical connection can be formed by compounds disposed between the panel component 120 and the IMPEC 110 or can be formed by chemical properties of the materials of the panel component 120 and/or the IMPEC 110 themselves. The chemical connection can be permanent or removable. Further, the chemical connection can be formed by a reaction (e.g., a compound that undergoes an exothermic reaction when the IMPEC 110 is formed in contact with the panel component 120) or can be the result of chemical properties (e.g., hydrogen bonding between chemical components of the IMPEC 110 and panel component 120). One of skill in the art will appreciate that a nearly limitless number of permutations for a chemical connection can be employed and that all such permutations are within the scope of the disclosed subject matter.

In accordance with another aspect, other components can be included in the injection molding of the panel component 120, the IMPEC 120, or combinations thereof. For example, where the panel component 120 is a touch sensitive panel with electronic connection leads extending therefrom, the electronic connection leads, for example, can be partially encapsulated in the IMPEC material during the corresponding injection molding of the IMPEC 110 to the panel component 120. One of skill in the art will appreciate that numerous other components can be either partially or fully encapsulated in the materials of the panel component 120 or the IMPEC 110 during the injection molding process and that all such inclusions of additional components are to be considered within the scope of the disclosed subject matter.

In addition to insert molding the panel component 120 and the IMPEC 110, system 100 can be formed by other injection molding processes. These other injection molding processes can include 2-shot, multi-shot, and/or co-injection molding techniques. For example, in 2-shot injection molding, the panel component 120 can be formed by one injection molding shot and the IMPEC 110 can be formed by the other injection molding shot. Similarly, for example, in a co-injection molding, the panel component 120 and IMPEC 110 can be contemporaneously formed from different materials in the same mold. Additional assemblies can be formed by techniques such as multi-shot injection molding, for example, an IMPEC 110 with cushioned grips, molded logos, or nearly a limitless number of other assemblies can be formed from multi-shot injection molding processes having additional injection molding shots.

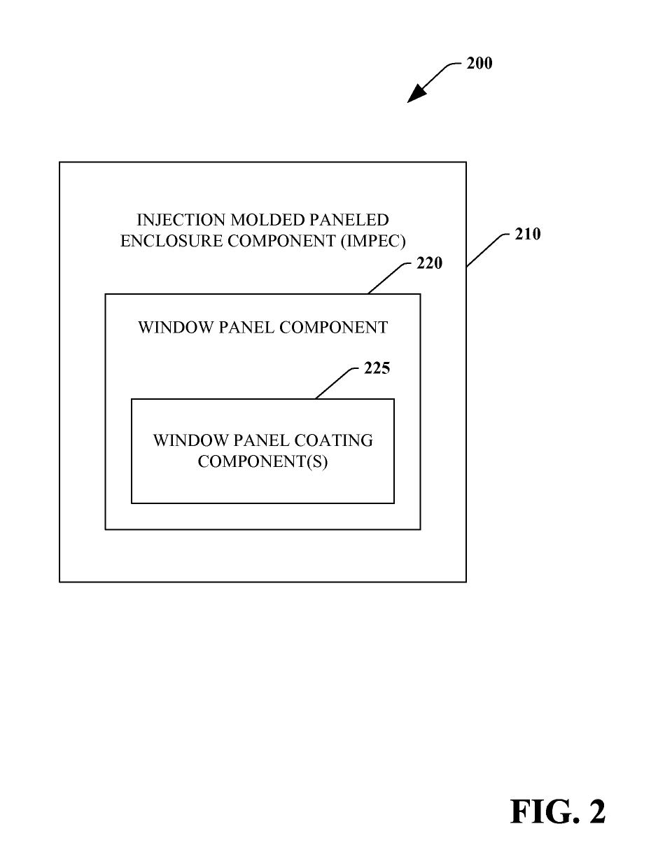

Turning to FIG. 2, illustrated is a system 200 that can facilitate an improved window paneled mobile device enclosure in accordance with an aspect of the subject matter disclosed herein. System 200 can include an IMPEC 210 that can be the same as, or similar to, IMPEC 110. System 200 can further include a window panel component 220, that can be the same as, or similar to, panel component 120. Window panel component 220 can generally be described as being transparent or translucent so as to function as a window. For example, this can allow the IMPEC 210 with the window panel component 220 to enclose a mobile electronic device, for example, having an LCD display, such that the LCD display can be viewed through the window panel component 220 by a mobile device user.

System 200 can lend itself well to 2-shot, multi-shot, and co-injection injection molding (as herein described). Window panel components 220 can often be formed from a single material, for example a translucent plastic, that can easily form connections (as herein described) with the IMPEC 210 that can also frequently be a single material, for example, a black polymer. For example, where 2-shot injection molding is employed, the window panel component 220 can be injection molded and then the IMPEC 210 can be molded to form a thermally welded connection between the IMPEC 210 and the window panel component 220.

System 200 can also be conducive to including window panel coating component 225. As will be appreciated by one of skill in the art, numerous types of coatings can be desirable on a window panel component 220. These coatings can include anti-glare coatings, anti-scratch coatings, privacy coatings, polarizing coatings, colored coatings, among a nearly a limitless number of other types of coatings. One of skill in the art will appreciate that all such coatings on the window panel component 220 are within the scope of the disclosed subject matter. The window panel coating components 225 can be applied to a window panel component 220 either before molding the IMPEC 210 (e.g., the window panel component 220 is formed, coated and then insert molded into the IMPEC 210); applied during injection molding (e.g., by chemical reactions with materials to form the window panel coatings during the molding of the window panel component 220); as an additional step before or between molding the window panel component 220 and molding the IMPEC 210 (e.g., as an additional injection in an multi-shot molding process, as separate process between the two molding steps, or before the injection of the window panel component by placing coatings in the region in which the window panel component will be formed); or after the IMPEC molding step but before completion of the molding process for the resulting enclosure (e.g., as a separate window coating process while the final enclosure is still curing).

In sum, system 200 can comprise a windowed panel component 220 injection molded with an IMPEC 210. The window can be treated or formed to include various types of coatings, if desired in the enclosure application. The injection molding processes for formation of the enclosure can include insert molding, co-injection, multi-shot, and 2-shot injection molding, among others. Further, the disclosed subject matter includes modification of any forming process to adapt the process to include applying coatings to the window panel component 220 at any point in the formation of the final enclosure assembly.

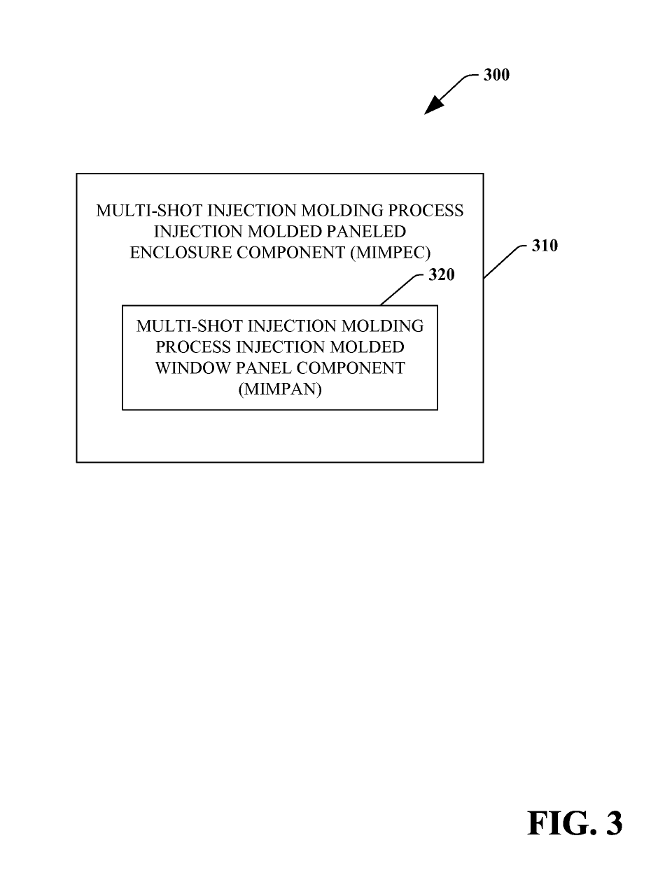

Turning to FIG. 3, illustrated is a system 300 that can facilitate an improved window paneled mobile device enclosure in accordance with an aspect of the subject matter disclosed herein. System 300 can include a multi-shot injection molded paneled enclosure component (MIMPEC) 310. The MIMPEC can be the same as, or similar to, the IMPEC 210, 110. The MIMPEC 310 can be formed by injection molding a multi-shot molding process injection molded window panel component (MIMPAN) 320 (that can be the same as, or similar to, window panel component 220 and/or panel component 120) and the MIMPEC 310 in a multi-shot injection molding process (e.g., the enclosure body and the window panel are both injection molded in the same mold sequentially or contemporaneously, as herein discussed).

Where multi-shot injection molding is employed, the material for the MIMPAN 320 can be the same or different than that used for the MIMPEC 3 10. Further, multi-shot injection molding is not limited to two injections in a molding process. Additional injection molding sequences can be employed to add additional molded features as herein discussed. For example, in a four-shot multi-shot injection molding process, the final assembly can be a mobile device enclosure wherein the first injection, for example, forms the window panel, the second injection forms a set of comfort grips, a third injection forms a series of shock absorbing supports for internal circuit boards, and a forth injection forms the body enclosure encapsulating portions of the first three injection assemblies to form a single final assembly into which the electronic components completing the device can be inserted and connected. One of skill in the art will appreciate that a nearly limitless number of injection sequences and molds can be employed to create an equally large number of custom mobile device enclosures, and that all such permutations that include at least one shot for the window panel and one shot for the enclosure body, such that the body and the panel are at least partially interconnected, are to be considered within the scope of the disclosed subject matter.

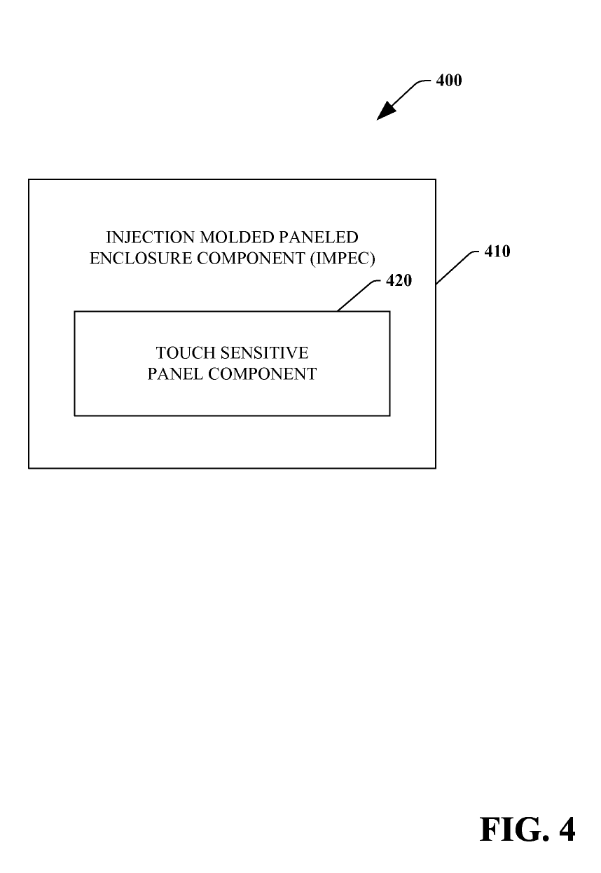

Turning to FIG. 4, illustrated is a system 400 that can facilitate an improved touch sensitive paneled mobile device enclosure in accordance with an aspect of the subject matter disclosed herein. System 400 can include an injection molded paneled enclosure component 410 that can be the same as, or similar to, MIMPEC 310, IMPEC 210, 110. System 400 can further include a touch sensitive panel component 420 that can be the same as, or similar to, MIMPAN 320, window panel component 220, panel component 120. Typically, processes to create touch sensitive panel components require that the substrates be substantially planar flat, where current injection molding processes typically do not create sufficiently planar flat surfaces, insert molding is the preferred process for achieving system 400. However, where injection molding processes become sufficiently advanced so as to form sufficiently planar flat surfaces, the process of forming touch sensitive panel component 420 by those injection molding processes as part of system 400 is to be considered within the scope of the disclosed subject matter.

Where the preferred injection molding process of insert molding a pre-formed touch sensitive panel component 420 with IMPEC 410 is employed, such process can facilitate more rugged enclosures and/or improved form factors. As discussed herein, the insert molding process can form IMPEC 410 with permanently or removably connected panels (e.g., touch sensitive panels in system 400). The connections to the enclosure body can be mechanical, chemical, adhesive, and/or weld-type connections as also discussed herein. Further, interconnects between the touch sensitive panel and to be installed internal electronic components (not illustrated) can be partially encapsulated as part of the injection molding of the IMPEC 410 body with the touch sensitive panel, offering further improvements if form factor and/or ruggedness.

In accordance with an aspect of disclosed subject matter, certain precautions can generally be followed when insert molding a touch sensitive panel component 420 with an IMPEC 410. One such precaution includes preventing overmolding onto the touch sensitive surface of the touch sensitive panel 420 so as not to degrade the touch sensitive aspect of the panel. This can easily be accomplished, for example, by using a touch sensitive panel component 420 that has a larger substrate surface area than the touch sensitive layers deposed thereon, allowing overmolding (e.g., by insert molding processes) of the non-touch sensitive portions of the touch sensitive panel component 420. In another example, where the touch sensitive portion of the panel and the substrate are of equal surface area, the insert molding process can be tailored to allow the connection between the IMPEC 410 and the touch sensitive panel component 420 to occur in areas that do not interfere with the touch sensitive aspects of the panel, for example by injection molding the IMPEC 410 posterior to the substrate where the touch sensitive layers are anterior to the substrate, by employing chemical connections, by employing mechanical connections, or by employing adhesive connections, all as herein described. One of skill in the art will appreciate that numerous means for causing the connection between the IMPEC 410 and the touch sensitive panel component 420 can be accomplished without damaging the touch sensitive features of the panel and that all such connections are considered within the scope of the disclosed subject matter.

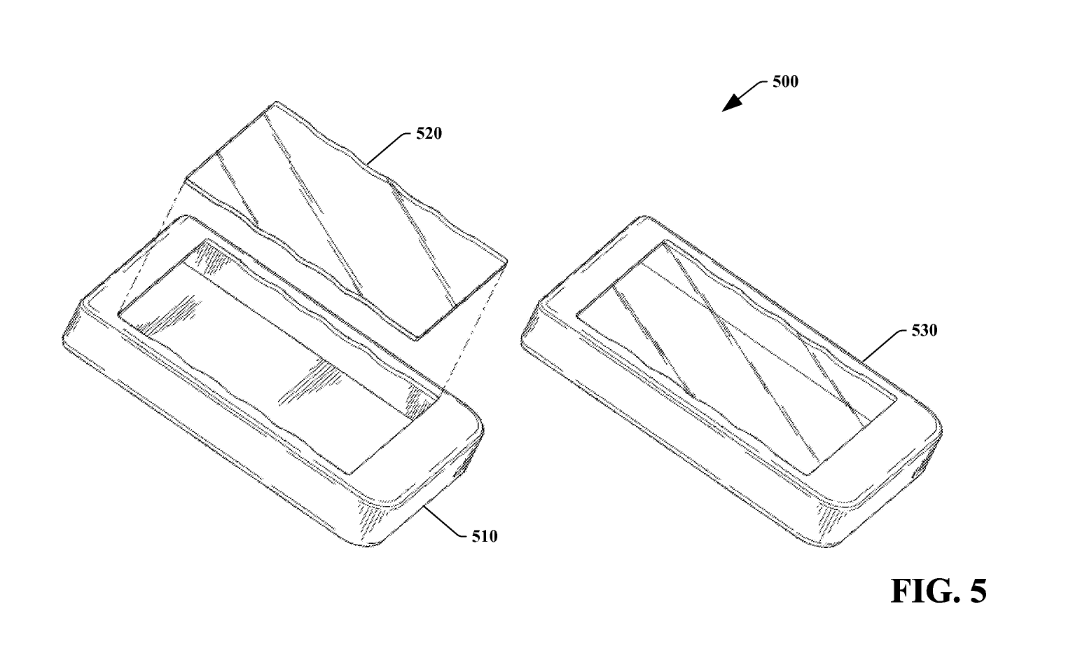

Turning to FIG. 5, illustrated is a schematic illustration of a system that can facilitate an improved paneled mobile device enclosure in accordance with an aspect of the subject matter disclosed herein. System 500 can include an injection molded enclosure body 510 that can be molded with panel 520. Enclosure body 500 can be the same as, or similar to, IMPEC 410, 210, 110, or MIMPEC 310 as herein described. Panel 520 can be the same as, or similar to, touch sensitive panel 420, MIMPAN 320, window panel component 220, or panel component 120, as herein described. Enclosure body 510 and panel 520 can be injection molded as herein described (e.g., injection molded, insert molded, 2-shot injection molded, multi-shot injection molded, or co-injection injection molded).

In an embodiment, enclosure body 510 can be injection molded with a preformed panel 520 (e.g., insert molded) such that a weld-type connection, mechanical connection, chemical connect, or adhesive connection is formed, as herein described, between enclosure body 510 and panel 520 to produce a final enclosure assembly 530. In another embodiment, where 2-shot, multi-shot, or co-injection injection molding processes are employed, the enclosure body 510 and the panel 520 can be formed in any order (e.g., the panel 520 can be formed before, after, or contemporaneously with the enclosure body 510) to form the final enclosure assembly 530. In still another embodiment, where panel 520 can be a window panel, a display panel, or a touch sensitive panel, as herein described, molding of the panel and the enclosure body can partially or entirely encapsulate other components (not illustrated) including interconnects, electronic components, shock absorbing components, mechanical strengtheners or stabilizers, ports, antenna housings, grips, or combinations thereof, among a myriad of other components that are germane to a final enclosure assembly for a mobile electronic device.

As illustrated, system 500 comprises a panel 520 disposed in a coplanar manner with a first side of the enclosure body 510. Enclosure body 510 further comprises at least one other side disposed in a non-coplanar manner with respect to the first side. Where enclosure body 510 employs one or more non-coplanar sides and a first side coplanar with the panel 520, and the enclosure body is injection molded with the panel 520 (e.g., injection molded, insert molded, 2-shot, multi-shot, co-injection injection molded, . . . ) additional structural rigidity can be achieved. Further, where, as illustrated in FIG. 5, the surface area of the panel 520 in comparison to the surface area of the first side of the enclosure body 510 increases (e.g., from small panels to larger panels consuming most of the surface are of the first side of the enclosure body 510), injection molding forming a singular final assembly (e.g., a contiguous final assembly) can add substantial ruggedness over conventional means of attaching a panel to a mobile device enclosure. One of skill in the art will appreciate that injection molding a panel with an enclosure body can produce a more rugged enclosure where there are one or more sides disposed non-coplanar to the first side, where the panel is large in comparison to the surface area of the first side, or combinations thereof, and that all mobile device enclosures displaying these features are considered within the scope of the disclosed subject matter.

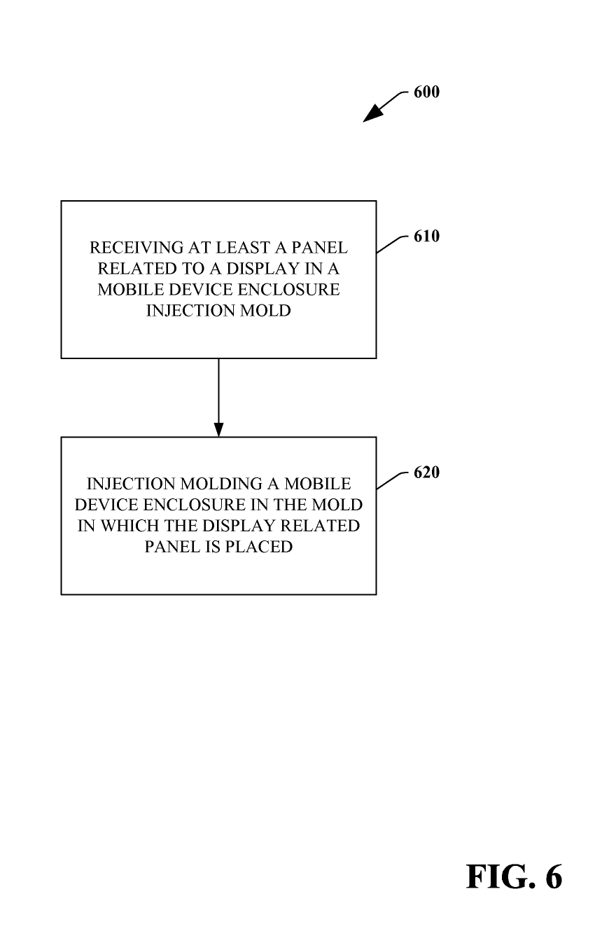

FIGS. 6-9 illustrate methodologies in accordance with the disclosed subject matter. For simplicity of explanation, the methodologies are depicted and described as a series of acts. It is to be understood and appreciated that the disclosed subject matter is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter.

Conventional methodologies generally employ mechanical fasteners, bezels, glues, or mechanical bonding techniques such as sonic welding or heat-stacking to attach a panel to a mobile device enclosure. For example, a conventional method can attach a window panel in a cell phone housing by gluing the window panel into a relief in the cell phone housing. As a second example, a conventional method can attach a display panel by sonically welding a bezel to a PDA enclosure body to mechanically trap the display screen between the bezel and the PDA enclosure body. As a third example, an LCD display screen can be fastened by bolts through mounting holes to a laptop screen enclosure. These conventional methods can produce final assemblies that lack ruggedness, can be prone to premature failures as a result of the connection between the panel and the enclosure body failing or degrading, and/or can result in non-optimal form factors.

In contrast, by employing injection molding methods to connect a panel to a mobile device enclosure body, ruggedness and form factor can be improved. Injection molding methods can include insert molding, 2-shot injection molding, multi-shot injection molding, and co-injection injection molding. Methods of forming paneled mobile device enclosures employing these injection molding methods can result in weld-type connections, mechanical connections, chemical connections, and/or adhesive connections between a panel and an enclosure body, as herein described.

Referring now to FIG. 6, illustrated is a methodology 600 that can form an improved paneled mobile device enclosure in accordance with an aspect of the subject matter disclosed herein. At 610 in methodology 600, a display related panel can be inserted into a mobile device enclosure injection mold. The panel can be a display panel, a window panel, or a touch sensitive panel as herein described. Where preformed components are inserted into an injection mold for further injection molding, the process is generally known as insert molding or overmolding.

At 620, a mobile device enclosure can be injection molded into the injection mold containing the panel inserted at 610. At this point, methodology 600 can end. Injection molding the enclosure body can form a weld-type connection between the panel inserted at 610 and the newly injected material (at 620) that forms at least a portion of the enclosure body. Similarly, by tailoring the injection molding process, a mechanical connection, chemical connection, or adhesive connection, as herein described, can be formed by the injection molding at 620. For example, where the panel inserted at 610 is a glass panel with tabs at the perimeter, the injection molding at 620 can encapsulate the tabs forming a mechanical connection between the glass panel and the injection molded enclosure body. Similarly, for example, the enclosure body can be molded around the perimeter of a glass panel that has been pretreated with a heat sensitive adhesive compound, wherein the heat from the molten material being injected to form the enclosure body can activate the thermal adhesive and form an adhesive bond between the perimeter of the glass panel and the newly formed enclosure body. One of skill in the art will appreciate that the injection molding process can be tailored to provide the desired type of connection between the panel and the enclosure body and that all such permutations are well within the scope of the herein disclosed subject matter.

In an aspect, inset molding can allow use of preformed panels and/or panels that are not conducive to injection molding themselves (for example, a touch sensitive panel as herein discussed, glass display panels, . . . ). In another aspect, where the panel is germane to injection molding processes, the preformed panel itself can be formed by injection molding in a separate process and then employed in methodology 600 as an insert in the insert molding process of forming a mobile device enclosure.

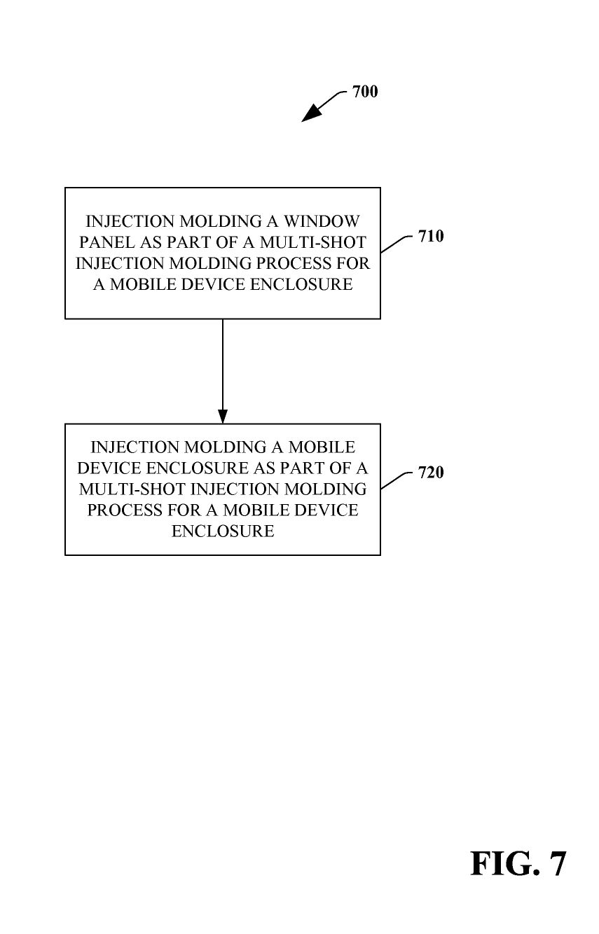

Referring now to FIG. 7, illustrated is a methodology 700 that can form an improved windowed paneled mobile device enclosure by multi-shot injection molding in accordance with an aspect of the subject matter disclosed herein. At 710 of methodology 700, injection molding can form a panel as part of a multi-shot injection molding process for forming an injection molded mobile device enclosure (e.g., 2-shot injection molding, multi-shot injection molding, co-injection molding, . . . ). At 720 of methodology 700, injection molding can form an enclosure body as part of a multi-shot injection molding process for forming an injection molded mobile device enclosure (e.g., 2-shot injection molding, multi-shot injection molding, co-injection injection molding, . . . ). At this point, method 700 can end. One of skill in the art will appreciate that the action blocks 710 and 720 can be performed in reverse order and/or can have additional actions interposed therebetween, before, and/or after, and will further appreciate that all such resulting methods are within the scope of the herein disclosed subject matter. For example, in a multi-shot injection molding process, such as the four-shot example given herein above, the additional actions of injection molding cushioned grips and injection molding shock absorbing members can be interposed between the actions of molding the panel and molding the enclosure body.

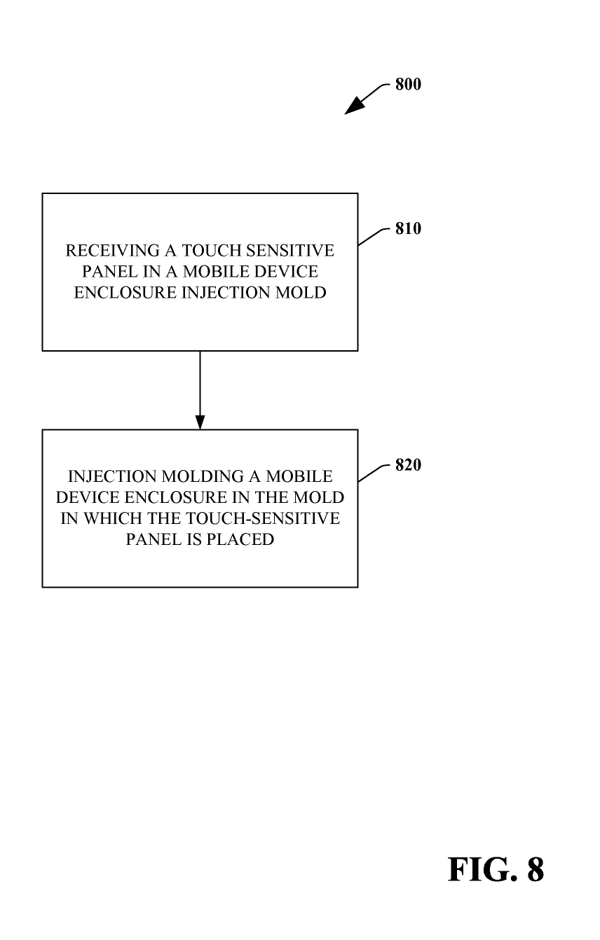

Referring now to FIG. 8, illustrated is a methodology 800 that can form an improved touch sensitive paneled mobile device enclosure in accordance with an aspect of the subject matter disclosed herein. At 810, a touch sensitive panel can be inserted in a mold for an injection molded mobile device enclosure. At 820, injection molding of the mobile device enclosure with the inserted touch sensitive panel inserted at 810 can occur. At this point, methodology 800 can end.

As discussed herein, methods of forming mobile device enclosures by insert molding of enclosure bodies with inserted touch sensitive panels can employ precautions to prevent damage to the touch sensitive aspects of the panel. These precautions can include using touch sensitive panels with larger substrates that the area covered by the touch sensitive layers and connecting the injection molded enclosure body to only the portions of the substrate not encompassed by the touch sensitive layers. Further, these precautions can include injection molding the enclosure body in a manner not disturbing the touch sensitive layers, where the touch sensitive layers are of equal area as the substrate, by, for example, connecting to the posterior of the substrate while the touch sensitive layers are anterior to the substrate.

The methods of forming a paneled injection molded mobile device enclosure can further include forming a paneled injection molded mobile device enclosure wherein the mobile device enclosure body formed has a first side in which the panel is disposed in a coplanar manner and at least a second side that is disposed in a non-coplanar manner. Further, the methods of forming a paneled injection molded mobile device enclosure can further include forming a paneled injection molded mobile device enclosure wherein the area of the panel can be large with respect to the area of the first side in which the panel is disposed. Where injection molding is employed to form the body of the enclosure, additional ruggedness can be achieved by forming a plurality of non-coplanar sides. Further, where injection molding of the body of the enclosure to the panel forms a contiguous final paneled enclosure assembly, and the panel area is large in respect to the first side of the enclosure, additional ruggedness can be achieved. Moreover, the methods of forming a paneled injection molded mobile electronic device can include designs to reduce the overall form factor of the connection between the panel and the body of the enclosure resulting in a more optimal overall form factor for the enclosed mobile electronic device. For example, a window panel can be insert molded with the enclosure body such that the panel is coplanar with the first face of the enclosure body, resulting in a connection that is the same, or nearly the same, as the thickness of the window panel alone. This represents a substantial improvement over conventional methodologies as herein described.

What has been described above includes examples of aspects of the disclosed subject matter. It is, of course, not possible to describe every conceivable combination of components or methodologies for purposes of describing the disclosed subject matter, but one of ordinary skill in the art will recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A system that facilitates injection molded paneled mobile device enclosures that are rugged, display improved form factors, or combinations thereof, comprising:
a panel component; and
an enclosure body component, wherein the enclosure body component is injection molded to at least partially form one or more connections with the panel component.

2. The system of claim 1, wherein the one or more connections include weld-type connections, thermal bond connections, mechanical connections, chemical connections, adhesive connections, or combinations thereof.

3. The system of claim 1, wherein the panel component is an inserted panel component and the enclosure body component is insert molded with the inserted panel component.

4. The system of claim 3, wherein the inserted panel component is at least one of a display panel, a window panel, or a touch sensitive panel.

5. The system of claim 1, wherein the enclosure body component is at least partially formed by at least one injection of a multi-shot injection process and wherein the panel component is at least partially formed by at least one other injection of the same multi-shot injection process.

6. The system of claim 5, wherein the panel component is at least one of a window panel, a display panel, or a touch sensitive panel.

7. The system of claim 5, wherein the multi-shot injection process comprises two or more sequential injections.

8. The system of claim 5, wherein the multi-shot injection process comprises two or more contemporaneous injections.

9. The system of claim 1, further comprising at least one coating layer or material disposed on the panel component.

10. The system of claim 9, wherein the at least one coating layer or material enhances at least one property of the panel component including reducing glare, improving abrasion resistance, optical polarization, reduced reflective properties, privacy, coloration, or combinations thereof.

11. The system of claim 1, facilitating improved rigidity, wherein the enclosure body component further comprises a first side in which the panel component is disposed and at least one other side disposed in a non-coplanar manner with respect to the first side.

12. The system of claim 1, facilitating improved rigidity, wherein the area of an opening in the enclosure body component related to the panel component is large with respect to the area of a side of the enclosure body component having the panel component.

13. The system of claim 1, wherein the panel component is a touch sensitive panel having a substrate area larger than the area forming the touch sensitive components of the panel component and the injection molding of the enclosure body component is tailored to form the one or more connections only with portions of the substrate not encompassed by the touch sensitive components of the panel component.

14. The system of claim 1, wherein the panel component is a touch sensitive panel having a substrate area equivalent to the area forming the touch sensitive components of the panel component and the injection molding of the enclosure body component is tailored to form the one or more connections only with portions of the substrate not encompassed by the touch sensitive components of the panel component.

15. The system of claim 1, wherein the injection molding of the enclosure body component results in the panel component being permanently, semi-permanently, or removably connected to the enclosure body component.

16. The system of claim 1, wherein the injection molding of the enclosure body component, the panel component, or a combination thereof partially or completely encapsulates additional electronic components, mechanical components, electrical components, mechanical connective components, electronic connective components, or combinations thereof.

17. An electronic device at least partially enclosed by the paneled enclosure of the system of claim 1.

18. A method that facilitates forming an injection molded paneled mobile device enclosure comprising:
receiving a preformed panel component related to a display in an injection mold for a mobile device enclosure;
injection molding at least a portion of an enclosure body component with the inserted panel component forming at least one connection between the enclosure body component and the panel component and
wherein the injection molding process comprises at least one of injection molding, insert molding, 2-shot injection molding, multi-shot injection molding, co-injection molding, or combinations thereof.

19. The method of claim 18, wherein the preformed panel component is a touch sensitive panel, display panel, or combination thereof, and the injection molding process is tailored to prevent damage to the functional aspects of the panel component.

20. A method that facilitates forming an injection molded paneled mobile device enclosure comprising:
injection molding at least a portion of a panel component related to a display in an injection mold for a mobile device enclosure;
injection molding at least a portion of an enclosure body component with the panel component in the same injection mold, forming at least one connection between the enclosure body component and the panel component; and
wherein the injection molding process comprises at least one of injection molding, insert molding, 2-shot injection molding, multi-shot injection molding, co-injection molding, or combinations thereof.
